(19) United States
(12) Patent Application Publication
(10) Pub. No.: US 2025/0331001 A1
(43) Pub. Date: Oct. 23, 2025

(54) METHOD, DEVICE AND COMPUTER STORAGE MEDIUM OF COMMUNICATION

(71) Applicant: NEC Corporation, Tokyo (JP)

(72) Inventors: Da WANG, Beijing (CN); Gang WANG, Beijing (CN)

(73) Assignee: NEC Corporation, Tokyo (JP)

(21) Appl. No.: 18/868,229

(22) PCT Filed: May 31, 2022
(86) PCT No.: PCT/CN2022/096368

§ 371 Date: Nov. 22, 2024

(51) Int. Cl. H04W 72/25; H04B 17/318; H04L 43/0894

(52) U.S. Cl. CPC H04W 72/25; H04B 17/328; H04L 43/0894

(57) ABSTRACT

Embodiments of the present disclosure relate to methods, devices and computer readable media of communication. A first terminal device receives, from a first network device, a sidelink configuration comprising a first configuration of packet duplication for at least one SL RB. The first terminal device determines, at least based on the first configuration, a set of activated RLC entities associated with a PDCP entity for a SL RB, and transmits a set of duplications of a PDCP packet to a second terminal device via the set of activated RLC entities. In this way, packet duplication for sidelink transmission may be well supported.

### TECHNICAL FIELD

Embodiments of the present disclosure generally relate to the field of telecommunication, and in particular, to methods, devices and computer storage media of communication for packet duplication in sidelink transmission.

### BACKGROUND

New radio (NR) sidelink communication is an access stratum (AS) functionality enabling communication between two or more nearby user equipment (UE) using NR technology but not traversing any network node. Improving sidelink data reliability and latency is one important target, considering a safety requirement of service for vehicles in sidelink communication. Packet duplication is an efficient method to improve reliability and latency performance of sidelink transmission. However, packet duplication for sidelink transmission is still incomplete and needs to be further developed.

### SUMMARY

In general, embodiments of the present disclosure provide methods, devices and computer storage media of communication for packet duplication in sidelink transmission.

In a first aspect, there is provided a method of communication. The method comprises: receiving, at a first terminal device and from a first network device, a sidelink configuration comprising a first configuration of packet duplication for at least one sidelink radio bearer; determining, at least based on the first configuration, a set of activated radio link control (RLC) entities associated with a packet data convergence protocol (PDCP) entity for a sidelink radio bearer: and transmitting a set of duplications of a PDCP packet to a second terminal device via the set of activated RLC entities.

In a second aspect, there is provided a method of communication. The method comprises: receiving, at a second terminal device via a sidelink between the second terminal device and a first terminal device, a second configuration of packet duplication for at least one sidelink radio bearer; and transmitting information of the second configuration to a second network device.

In a third aspect, there is provided a method of communication. The method comprises: transmitting, at a first network device and to a first terminal device, a sidelink configuration comprising a first configuration of packet duplication for at least one sidelink radio bearer.

In a fourth aspect, there is provided a method of communication. The method comprises: receiving, at a second network device and from a second terminal device, information of a second configuration of packet duplication for at least one sidelink radio bearer; and transmitting, to the second terminal device, at least one of the following: a third configuration of packet duplication of a transmit side; or a fourth configuration of packet duplication of a receive side.

In a fifth aspect, there is provided a device of communication. The device comprises a processor configured to cause the device to perform the method according to any of the first to fourth aspects of the present disclosure.

In a sixth aspect, there is provided a computer readable medium having instructions stored thereon. The instructions, when executed on at least one processor, cause the at least one processor to perform the method according to any of the first to fourth aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure can be implemented;

FIG. 1B illustrates a schematic diagram of a user plane protocol stack in which some embodiments of the present disclosure can be implemented;

FIG. 1C illustrates a schematic diagram of a control plane protocol stack in which some embodiments of the present disclosure can be implemented;

FIG. 1D illustrates a schematic diagram of a user plane protocol stack for a sidelink traffic channel (STCH) in which some embodiments of the present disclosure can be implemented;

FIG. 1E illustrates a schematic diagram of a control plane protocol stack for a sidelink control channel (SCCH) for PC5-radio resource control (PC5-RRC) in which some embodiments of the present disclosure can be implemented;

FIG. 1F illustrates a schematic diagram of a control plane protocol stack for SCCH for PC5-signaling (PC5-S) in which some embodiments of the present disclosure can be implemented;

FIG. 1G illustrates a schematic diagram of activation or deactivation of packet duplication in which some embodiments of the present disclosure can be implemented;

FIG. 2 illustrates a schematic diagram illustrating a process of communication for packet duplication in sidelink transmission according to embodiments of the present disclosure;

FIG. 3 illustrates an example method of communication implemented at a first terminal device in accordance with some embodiments of the present disclosure;

FIG. 4 illustrates an example method of communication implemented at a second terminal device in accordance with some embodiments of the present disclosure;

FIG. 5 illustrates an example method of communication implemented at a first network device in accordance with some embodiments of the present disclosure;

FIG. 6 illustrates an example method of communication implemented at a second network device in accordance with some embodiments of the present disclosure; and

FIG. 7 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FRI (410 MHz to 7125 MHZ), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “packet duplication” may be interchangeably used with “PDCP duplication” or “PDCP packet duplication”. The term “carrier” may also be called as “cell” or “serving cell”.

Generally, increased sidelink data rate is motivated by applications such as sensor information (e.g., video) sharing between vehicles with high degree of driving automation. Commercial use cases could require data rates in excess of what is possible. Increased data rate may be achieved with support of sidelink carrier aggregation. Meanwhile, improving sidelink data reliability and latency is also one important target, considering a safety requirement of service for vehicles. Packet duplication is an efficient method to improve reliability and latency performance of sidelink transmission.

Embodiments of the present disclosure provide a solution of communication to support packet duplication for sidelink transmission. In the solution, a first terminal device as an initiating party of sidelink communication receives a sidelink configuration comprising a configuration of packet duplication for at least one sidelink radio bearer. The first terminal device determines, at least based on the configuration, a set of activated RLC entities associated with a PDCP entity for a sidelink radio bearer, and transmits, via the set of activated RLC entities, a set of duplications of a PDCP packet to a second terminal device as a peer party of the sidelink communication. In this way, packet duplication for sidelink transmission may be well supported.

Principles and implementations of the present disclosure will be described in detail below with reference to the figures.

### Example of Communication Network

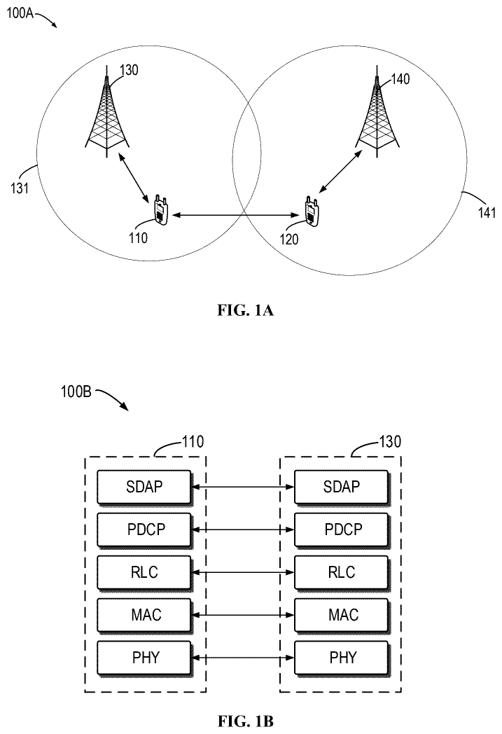

FIG. 1A illustrates a schematic diagram of an example communication network 100A in which some embodiments of the present disclosure can be implemented. As shown in FIG. 1A, the communication network 100A may include terminal devices 110 and 120 and network devices 130 and 140. The network devices 130 and 140 provide respective cells 131 and 141 to serve a terminal device.

In some embodiments, the terminal device 110 is located in the cell 131 and served by the network device 130. The terminal device 120 is located in the cell 141 and served by the network device 140.

It is to be understood that the number of devices and cells in FIG. 1A is given for the purpose of illustration without suggesting any limitations to the present disclosure. The communication network 100A may include any suitable number of network devices and/or terminal devices and/or cells adapted for implementing implementations of the present disclosure.

In some embodiments, a terminal device (for example, the terminal device 110 or 120) and a network device (for example, the network device 130 or 140) may communicate with each other via a channel such as a wireless communication channel on an air interface (e.g., Uu interface). The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH). Of course, any other suitable channels are also feasible.

In some embodiments, any two of terminal devices (for example, the terminal devices 110 and 120) may communicate with each other via a sidelink channel on a sidelink interface (e.g., PC5 interface). The sidelink channel may comprise a physical sidelink shared channel (PSSCH), a physical sidelink control channel (PSCCH), a physical sidelink feedback channel (PSFCH), and a physical sidelink broadcast channel (PSBCH). Of course, any other suitable channels are also feasible.

In some embodiments, the network devices 130 and 140 may be different network devices. In some embodiments, the network devices 130 and 140 may be the same network device.

In some embodiments, the terminal devices 110 and 120 may communicate with each other by means of one or multiple carriers for sidelink (not shown). In some embodiments where the terminal devices 110 and 120 communicate with each other by means of multiple carriers for sidelink, one of the multiple carriers for sidelink may be served as a primary carrier for sidelink and the remaining one or more carriers for sidelink may be served as secondary carriers for sidelink. For example, the primary carrier may be activated all the time, and the secondary carriers may be activated as needed. For another example, the radio link monitoring for sidelink may be performed on the primary carrier.

The communications in the communication network 100A may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The communications between a terminal device and a network device in communication network 100A may be performed in accordance with user plane and control plane protocol stacks. Generally speaking, for a communication device (such as a terminal device or a network device), there are a plurality of entities for a plurality of network protocol layers in a protocol stack, which can be configured to implement corresponding processing on data or signaling transmitted from the communication device and received by the communication device. FIG. 1B illustrates a schematic diagram 100B illustrating network protocol layer entities that may be established for user plane protocol stack at devices according to some embodiments of the present disclosure. For illustration, the following description is given by taking the terminal device 110 as an example of a terminal device and taking the network device 130 as an example of a network device.

As shown in FIG. 1B, each of the terminal device 110 and the network device 130 may comprise an entity for the L1 layer, i.e., an entity for a physical (PHY) layer (also referred to as a PHY entity), and one or more entities for upper layers (L2 and L3 layers, or upper layers) including an entity for a media access control (MAC) layer (also referred to as a MAC entity), an entity for a RLC layer (also referred to as a RLC entity), an entity for a PDCP layer (also referred to as a PDCP entity), and an entity for a service data application protocol (SDAP) layer (also referred to as a SDAP entity, which is established in 5G and higher-generation networks).

FIG. 1C illustrates a schematic diagram 100C illustrating network protocol layer entities that may be established for control plane protocol stack at devices according to some embodiments of the present disclosure. As shown in FIG. 1C, each of the terminal device 110 and the network device 130 may comprise an entity for the L1 layer, i.e., an entity for a PHY layer (also referred to as a PHY entity), and one or more entities for upper layers (L2 and L3 layers) including an entity for a MAC layer (also referred to as a MAC entity), an entity for a RLC layer (also referred to as a RLC entity), an entity for a PDCP layer (also referred to as a PDCP entity), and an entity for a RRC layer (also referred to as a RRC entity). The RRC layer may be also referred to as an access stratum (AS) layer, and thus the RRC entity may be also referred to as an AS entity. As shown in FIG. 1C, the terminal device 110 may also comprise an entity for a non-access stratum (NAS) layer (also referred to as a NAS entity). An NAS layer at the network side is not located in a network device and is located in a core network (CN, not shown). In some cases, these entities are in a stack structure.

Generally, channels between the RRC layer and PDCP layer are called as radio bearers. A terminal device (for example, the terminal device 110 or 120) may be configured with at least one data radio bearer (DRB) for bearing data plane data and at least one signaling radio bearer (SRB) for bearing control plane data.

The communications between terminal devices in the communication network 100A may be performed in accordance with control plane protocol stacks. FIG. 1D illustrates a schematic diagram 100D of a user plane protocol stack for a STCH in which some embodiments of the present disclosure can be implemented. For illustration, the following description is given by taking the terminal devices 110 and 120 as examples of the terminal devices.

As shown in FIG. 1D, each of the terminal devices 110 and 120 may comprise an entity for the L1 layer, i.e., an entity for a PHY layer (also referred to as a PHY entity), and one or more entities for upper layers (L2 and L3 layers, or upper layers) including an entity for a MAC layer (also referred to as a MAC entity), an entity for a RLC layer (also referred to as a RLC entity), an entity for a PDCP layer (also referred to as a PDCP entity), and an entity for a SDAP layer (also referred to as a SDAP entity, which is established in 5G and higher-generation networks).

FIG. 1E illustrates a schematic diagram 100E of a control plane protocol stack for SCCH for PC5-RRC in which some embodiments of the present disclosure can be implemented. For illustration, the following description is given by taking the terminal devices 110 and 120 as examples of the terminal devices.

As shown in FIG. 1E, each of the terminal devices 110 and 120 may comprise an entity for the L1 layer, i.e., an entity for a PHY layer (also referred to as a PHY entity), and one or more entities for upper layers (L2 and L3 layers, or upper layers) including an entity for a MAC layer (also referred to as a MAC entity), an entity for a RLC layer (also referred to as a RLC entity), an entity for a PDCP layer (also referred to as a PDCP entity), and an entity for a PC5-RRC layer (also referred to as a PC5-RRC entity).

In some embodiments, a RRC entity and a PC5-RRC entity in a terminal device may be the same entity (e.g. logical entity). Of course, the RRC entity and the PC5-RRC entity may be different entities (e.g. logical entities). In some embodiments, a RRC layer and a PC5-RRC layer in a terminal device may be realized as the same layer. Of course, the RRC layer and the PC5-RRC layer may be realized as different layers.

FIG. IF illustrates a schematic diagram 100F illustrating a control plane protocol stack for SCCH for PC5-S in which some embodiments of the present disclosure can be implemented. As shown in FIG. 1F, each of the terminal devices 110 and 120 may comprise an entity for the L1 layer, i.e., an entity for a PHY layer (also referred to as a PHY entity), and one or more entities for upper layers (L2 and L3 layers) including an entity for a MAC layer (also referred to as a MAC entity), an entity for a RLC layer (also referred to as a RLC entity), an entity for a PDCP layer (also referred to as a PDCP entity), and an entity for a PC5-S layer (also referred to as a PC5-S entity).

Generally, a PC5-RRC layer may manage a PC5 RRC connection and a PC5-S layer may manage a PC5 unicast link. Channels between a PC5-RRC layer and PDCP layer are called as sidelink radio bearers (SL RBs). A terminal device (for example, the terminal device 110 or 120) may be configured with at least one sidelink DRB (SL DRB) for bearing data plane data and at least one sidelink SRB (SL SRB) for bearing control plane data.

For each PC5 RRC connection of unicast, one SL SRB (e.g., SL-SRB0) is used to transmit one or more PC5-S messages before PC5-S security has been established. One SL SRB (e.g., SL-SRB1) is used to transmit one or more PC5-S messages to establish PC5-S security. One SL SRB (e.g., SL-SRB2) is used to transmit, after PC5-S security has been established, one or more PC5-S messages which are protected. One SL SRB (e.g., SL-SRB3) is used to transmit a PC5-RRC signaling which is protected and only transmit the PC5-RRC signaling after PC5-S security has been established.

FIG. 1G illustrates a schematic diagram 100G of activation or deactivation of packet duplication in which some embodiments of the present disclosure can be implemented. As shown in FIG. 1G, when packet duplication is activated or configured for a terminal device (for example, the terminal device 110) as an initiating party of sidelink communication, a PDCP packet from a PDCP entity of the terminal device 110 may be repeatedly submitted to a plurality of RLC entities (in this example, only two RLC entities 151 and 152 are shown for illustration) of the terminal device 110 via respective RLC bearer or channels. The PDCP entity may be associated with a quality of service (QoS) flow. RLC entities in the plurality of RLC entities may correspond to different logical channels which have respective logical channel identities (LCIDs). The PDCP packet may be transmitted to another terminal device (for example, the terminal device 120) as a peer party of the sidelink communication via the logical channels. RLC entities 161 and 162 of the terminal device 120 may submit received PDCP packets to a PDCP entity of the terminal device 120 associated with the QoS flow.

When packet duplication is deactivated or not configured for the terminal device 110, a single RLC entity (for example, the RLC entity 151) of the terminal device 110 via a respective RLC bearer or channel. The PDCP entity may be associated with a QoS flow. The PDCP packet may be transmitted to the terminal device 120 via a logical channel corresponding to the RLC entity. A RLC entity 161 of the terminal device 120 may submit a received PDCP packet to a PDCP entity of the terminal device 120 associated with the QoS flow.

Embodiments of the present disclosure provide a solution of communication to support packet duplication for sidelink transmission. According to the embodiments of the present disclosure, packet duplication may be applied to broadcast, groupcast and unicast of sidelink transmission. Packet duplication for sidelink transmission may be applied to a terminal device in a connected state, an inactive state and an idle state. Packet duplication may be supported for a SL DRB for user plane data and a SL SRB for control plane data. The SL SRB may be at least one of SL SRB0, SL SRB1, SL SRB2 or SL SRB3. Packet duplication with two and more than two RLC entities may be supported.

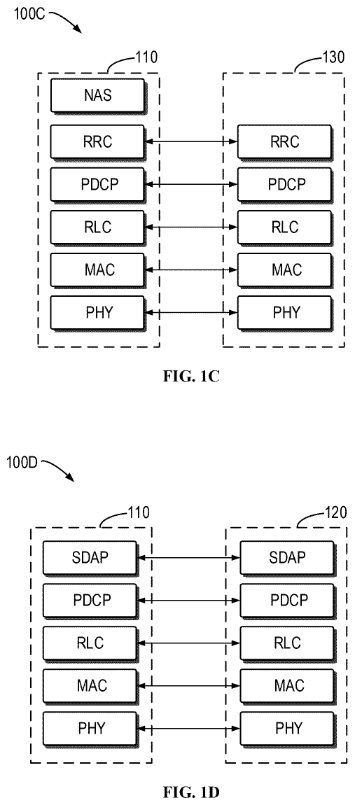

For illustration, more details of the solution will be described with reference to FIG. 2.

### Example Implementation of Packet Duplication For Sidelink Transmission

FIG. 2 illustrates a schematic diagram illustrating a process 200 of communication for packet duplication in sidelink transmission according to embodiments of the present disclosure. For the purpose of discussion, the process 200 will be described with reference to FIG. 1A. The process 200 may involve the terminal devices 110 and 120 and the network devices 130 and 140 as illustrated in FIG. 1A. It is assumed that the network device 130 provides a serving cell (e.g., the cell 131) for the terminal device 110. The network device 140 provides a serving cell (e.g., the cell 141) for the terminal device 120.

### Configuration of Packet Duplication

As shown in FIG. 2, the network device 130 transmits 210, to the terminal device

110, a sidelink configuration comprising a configuration (for convenience, also referred to as a first configuration herein) of packet duplication for at least one SL RB.

In some embodiments, the network device 130 may transmit the sidelink configuration via system information. In some embodiments, the network device 130 may transmit the sidelink configuration via a RRC reconfiguration message.

In some embodiments, a SL RB in the at least one SL RB may be a SL DRB. In some embodiments, a SL RB in the at least one SL RB may be a SL SRB.

In some embodiments, the first configuration may comprise a set of carriers associated with a logical channel of a SL RB when the packet duplication is activated. In other words, the first configuration may comprise a set of carriers associated with or allowed for a logical channel of a SL RB when the packet duplication is activated.

In some embodiments, the first configuration may comprise a threshold (for convenience, also referred to as a first threshold herein) used for determination of the number of activated RLC entities in the set of activated RLC entities. In some embodiments, the first threshold may be associated with a QoS parameter of the PDCP packet. In some embodiments, the first threshold may be associated with a sidelink reference signal receiving power (SL RSRP) of a carrier. In some embodiments, the first threshold may be associated with both the QoS parameter of the PDCP packet and the SL RSRP of the carrier. It is to be understood that the first threshold may adopt any other suitable forms.

In some embodiments where SL RB is SL SRB, the first configuration may comprise a set of LCIDs of logical channels used for the packet duplication. Alternatively, the set of LCIDs may be hard coded in the specifications. That is, one or more specific LCIDs may be reserved as an ID of a logical channel of RLC entity for duplication transmission of one SL SRB.

In some embodiments, the first configuration may comprise information of a primary carrier for sidelink. In other words, the network device 120 may transmit, to the terminal device 110, information of which carrier is the primary carrier for sidelink.

In some embodiments, the first configuration may comprise an indication indicating activation of the packet duplication. In some embodiments, the first configuration may comprise an indication indicating which RLC entities are activated.

It is to be understood that the first configuration may comprise any combination of the above information and any other suitable information.

In some embodiments, the first configuration may be pre-configured to the terminal device 110 and may be used when the terminal device 110 is out of coverage.

### Request of Configuration of Packet Duplication

Continue to refer to FIG. 2, in some embodiments, the network device 130 may receive 205, from the terminal device 110, a message requesting packet duplication for one destination or a sidelink QoS flow. In response to the message, the network device 130 may transmit the first configuration. For example, based on the requested information, the network device 130 may decide whether to configure packet duplication for the terminal device 110 and provide a proper configuration.

In some embodiments, the terminal device 110 in a connected state may transmit the message to request the network device 130 to configure packet duplication. In some embodiments, the terminal device 110 may set, in the message, an indication of request of packet duplication or requested number of RLC entities, an associated destination identity, or an identity of a sidelink QoS flow. In some embodiments, the terminal device 110 may transmit a SidelinkUEInformationNR message or any other suitable messages to request packet duplication.

In this way, a network may receive the latest information of sidelink transmission from a sidelink terminal device, and may configure packet duplication for the sidelink terminal device.

### UE-to-UE Configuration

In some embodiments where sidelink transmission is unicast, upon reception of the first configuration, the terminal device 110 may transmit 220, to the terminal device 120 via a sidelink between the terminal devices 110 and 120, a configuration (for convenience, also referred to as a second configuration herein) of packet duplication for at least one sidelink radio bearer. In some embodiments, the terminal device 110 may transmit the second configuration to the terminal device 120 by a PC5 RRC message, for example, RRCReconfigurationSidelink message or any other suitable messages.

In some embodiments, a SL RB in the at least one SL RB may comprise a SL DRB. In some embodiments, a SL RB in the at least one SL RB may comprise a SL SRB.

In some embodiments, the second configuration may comprise an indication indicating activation of the packet duplication. In some embodiments, the second configuration may comprise an indication indicating which RLC entities are activated.

In some embodiments, the second configuration may comprise the number of secondary RLC entities associated with a SL RB. In other words, the second configuration may comprise the number of additional RLC entities associated with a SL RB. In some embodiments, the second configuration may comprise the total number of RLC entities associated with a SL RB.

In some embodiments, the second configuration may comprise a set of RLC configurations for a set of secondary RLC entities. A secondary RLC entity may also be referred to as an additional RLC entity.

In some embodiments, the second configuration may comprise a set of LCIDs of logical channels used for a set of secondary RLC entities for the packet duplication.

In some embodiments, the second configuration may comprise a set of carriers associated with a SL RB when the packet duplication is activated.

In some embodiments, the second configuration may comprise a threshold (for convenience, also referred to as a second threshold herein) used for triggering the terminal device 120 to transmit an indication to the terminal device 110, the indication indicating activation or deactivation of RLC entities for the packet duplication.

It is to be understood that the second configuration may comprise any combination of the above information and any other suitable information.

In some embodiments, for broadcast and groupcast sidelink transmission, a LCID of a secondary or additional RLC entity may be hard coded in the specification. That is, one or more specific LCIDs are reserved as an ID of a logical channel of a RLC entity for duplication transmission of one SL DRB used for broadcast and groupcast.

### Report of Packet Duplication

Continue to refer to FIG. 2, upon reception of the second configuration, the terminal device 120 may transmit 230 information of the second configuration to the network device 140. In other words, the terminal device 120 may transmit information of packet duplication to the network device 140. For example, the terminal device 120 may transmit the information of the second configuration in a SidelinkUEInformationNR message or any other suitable messages.

In some embodiments, the information of the second configuration may comprise the number of secondary RLC entities associated with a SL RB. In some embodiments, the information of the second configuration may comprise the total number of RLC entities associated with the SL RB. In some embodiments, the information of the second configuration may comprise a set of LCIDs of logical channels used for a set of secondary RLC entities for the packet duplication. In some embodiments, the information of the second configuration may comprise a set of carriers associated with a SL RB when the packet duplication is activated. In some embodiments, the information of the second configuration may comprise the second threshold used for triggering the terminal device 120 to transmit an indication to the terminal device 110, the indication indicating activation or deactivation of RLC entities for the packet duplication. In some embodiments, the information of the second configuration may comprise an indication indicating activation of packet duplication for a SL RB. In some embodiments, the information of the second configuration may comprise an indication indicating which RLC entities are activated. It is to be understood that the information of the second configuration may comprise all or part of contents of the second configuration.

Based on the information of the second configuration reported from the terminal device 120, the network device 140 may transmit 240 a configuration of packet duplication to the terminal device 120. In some embodiments, for example, in case of bi-directional traffic (e.g., in RLC acknowledgement mode (AM)), the network device 140 may transmit a configuration (for convenience, also referred to as a third configuration herein) of packet duplication of a transmit (Tx) side. In some embodiments, the network device 140 may transmit a configuration (for convenience, also referred to as a fourth configuration herein) of packet duplication of a receive (Rx) side. In some embodiments, the fourth configuration may comprise the second threshold used for triggering the terminal device 120 to transmit an indication to the terminal device 110, the indication indicating activation or deactivation of RLC entities for the packet duplication.

In some embodiments, the network device 140 may transmit both of the third and fourth configurations.

In summary, based on the reported information of the second configuration, the network device 140 may decide whether to configure packet duplication for the terminal device 120 and provide a proper configuration.

### Determination of Activated RLC Entity

Continue to refer to FIG. 2, at least based on the first configuration, the terminal device 110 determines 250 a set of activated RLC entities associated with a PDCP entity for a SL RB. In some embodiments, the SL RB may be a SL DRB. In some embodiments, the SL RB may be a SL SRB.

If all the RLC entities associated with the PDCP entity of the SL RB are activated all the time, it may result in unnecessary redundant transmission and increase channel congestion possibility and UE power usage. Through the determination of the set of activated RLC entities according to embodiments of the present disclosure, packet duplication at a RLC entity may be only activated when needed, and radio resource usage over sidelink may be saved and UE power may be saved.

In some embodiments, the set of activated RLC entities may be a sub-group of all configured RLC entities. In some embodiments, the set of activated RLC entities may be all configured RLC entities. In some embodiments, the number of RLC entities in the set of activated RLC entities may be any suitable integer, for example, 1, 2, 3, 4, or more value.

In some embodiments, packet duplication using all RLC entities is always activated for SL SRB once configured.

In some embodiments, a mapping between RLC entities/logical channels and carriers for sidelink may be up to UE implementation. In some embodiments, a mapping between RLC entities/logical channels and carriers for sidelink may be based on a configuration of allowed carriers for each logical channel.

For illustration, some example embodiments of determination of the set of activated RLC entities will be described in connection with Embodiments 1 to 4.

### Embodiment 1

In this embodiment, the terminal device 110 may determine 251 the set of activated RLC entities from RLC entities configured for the packet duplication based on a QoS parameter of a PDCP packet.

In some embodiments, the QoS parameter may be associated with a reliability requirement of the PDCP packet. In some embodiments, the QoS parameter may be a latency requirement of the PDCP packet.

In some embodiments, if a value of the QoS parameter is below a threshold QoS parameter value, the terminal device 110 may determine that the RLC entities configured for the packet duplication are activated. If a value of the QoS parameter is below the threshold QoS parameter value, the terminal device 110 may determine that a predetermined number of RLC entities are activated.

In some embodiments, the threshold QoS parameter value may be configured by the network device 130, e.g., in system information or RRC reconfiguration message. In some embodiments, the threshold QoS parameter value may be pre-configured to the terminal device 110. For example, the threshold QoS parameter value may be configured or pre-configured as the first threshold as described above.

### Embodiment 2

In this embodiment, the terminal device 110 may determine 252 the set of activated RLC entities from RLC entities configured for the packet duplication based on SL RSRP of a carrier for sidelink.

In some embodiments, the carrier may be a carrier having a highest SL RSRP among carriers of the terminal device 110. In some embodiments, the carrier may be a primary carrier.

In some embodiments, SL RSRP may be measured by the terminal device 110 itself. In some embodiments, SL RSRP may be measured based on measurement results feedback from the terminal device 120.

In some embodiments, if the SL RSRP of the carrier is below threshold RSRP, the terminal device 110 may determine that the RLC entities configured for the packet duplication are activated. If the SL RSRP of the carrier is below threshold RSRP, the terminal device 110 may determine that a predetermined number of RLC entities are activated.

In some embodiments, the threshold RSRP may be configured by the network device 130, e.g., in system information or RRC reconfiguration message. In some embodiments, the threshold RSRP may be pre-configured to the terminal device 110. For example, the threshold RSRP may be configured or pre-configured as the first threshold as described above.

### Embodiment 3

In this embodiment, the terminal device 110 may receive 253, from the network

device 130, an indication indicating activation or deactivation of RLC entities for the packet duplication, and determine 253′ the set of activated RLC entities based on the indication.

In some embodiments, the indication may be carried in system information. In some embodiments, the indication may be carried in a RRC message. In some embodiments, the indication may be carried in a medium access control (MAC) control element (CE).

In some embodiments, the indication may comprise an identity of the SL RB on an air interface. For example, the identity of the SL RB may be SLRB Uu ConfigIndex. Of course, any other suitable forms are also feasible.

In some embodiments, the indication may comprise a bit indicating whether the packet duplication is activated or deactivated for the SL RB. For example, 1/true may means that packet duplication is activated, and 0/false may means that packet duplication is deactivated. As another example, 1/true may means that packet duplication is deactivated, and 0/false may means that packet duplication is activated.

In some embodiments, the indication may comprise a bitmap indicating whether each RLC entity is activated or deactivated for the SL RB. Each bit in the bitmap is associated with a RLC bearer configuration of one of the RLC entities for the packet duplication. In other words, the index for each bit is determined by an ascending order of indexes of the RLC bearer configurations of all RLC entities for the packet duplication.

For example, if the bit is 1/true, it means that the associated RLC entity is activated for packet duplication. If the bit is 0/false, it means that the associated RLC entity is deactivated for packet duplication. As another example, if the bit is 1/true, it means that the associated RLC entity is deactivated for packet duplication. If the bit is 0/false, it means that the associated RLC entity is activated for packet duplication.

In some embodiments where the indication is carried in a MAC CE, the size of the MAC CE may be 2 bytes.

### Embodiment 4

In this embodiment, the terminal device 110 may receive 254, from the terminal device 120, an indication indicating activation or deactivation of RLC entities for the packet duplication, and determine 254′ the set of activated RLC entities based on the indication.

In some embodiments, the indication may be carried in a PC5 RRC message. For example, the PC5 RRC message may be a RRCReconfigurationSidelink message or any other suitable messages. In some embodiments, the indication may be carried in a MAC CE.

In some embodiments, the indication may comprise an identity of the SL RB on a sidelink interface. For example, the identity of the SL RB may be SLRB PC5 ConfigIndex. Of course, any other suitable forms are also feasible.

In some embodiments, the indication may comprise a bit indicating whether the packet duplication is activated or deactivated for the SL RB. For example, 1/true may means that packet duplication is activated, and 0/false may means that packet duplication is deactivated. As another example, 1/true may means that packet duplication is deactivated, and 0/false may means that packet duplication is activated.

In some embodiments, the indication may comprise a bitmap indicating whether each RLC entity is activated or deactivated for the SL RB. Each bit in the bitmap is associated with a LCID of one of the RLC entities for the packet duplication. In other words, the index for each bit is determined by an ascending order of LCIDs of all RLC entities for the packet duplication.

For example, if the bit is 1/true, it means that the associated RLC entity is activated for packet duplication. If the bit is 0/false, it means that the associated RLC entity is deactivated for packet duplication. As another example, if the bit is 1/true, it means that the associated RLC entity is deactivated for packet duplication. If the bit is 0/false, it means that the associated RLC entity is activated for packet duplication.

In some embodiments, the terminal device 120 may transmit the indication to the terminal device 110 based on UE implementation. In some embodiments, the terminal device 120 may transmit the indication to the terminal device 110 upon a condition is met.

In some embodiments, if QoS performance of a SL RB is worse than threshold performance, the terminal device 120 may transmit the indication of activation of RLC entities for packet duplication. In some embodiments, if QoS performance of a SL RB is better than threshold performance, the terminal device 120 may transmit the indication of deactivation of RLC entities for packet duplication. In some embodiments, the QoS performance may be reliability performance, like packets error rate. For example, if unsuccessful reception of a predetermined number of packets occurs, the terminal device 120 may transmit the indication of activation of RLC entities for packet duplication. Otherwise, the terminal device 120 may transmit the indication of deactivation of RLC entities for packet duplication. This is merely an example, and is not intended for limitation.

In some embodiments, the threshold performance may be configured by the terminal device 110. For example, the threshold performance may be configured as the second threshold in the second configuration as described above. In some embodiments, the threshold performance may be configured by the network device 140. For example, the threshold performance may be configured as the second threshold in the fourth configuration as described above.

In some embodiments, if a channel condition of the sidelink is worse than a threshold condition, the terminal device 120 may transmit the indication of activation of RLC entities for packet duplication. In some embodiments, if the channel condition of the sidelink is better than the threshold condition, the terminal device 120 may transmit the indication of deactivation of RLC entities for packet duplication.

In some embodiments, the channel condition may be determined based on SL RSRP. In some embodiments, the channel condition may be determined based on a channel busy ratio (CBR). Of course, any other suitable ways are also feasible.

In some embodiments, the threshold condition may be configured by the terminal device 110. For example, the threshold condition may be configured as the second threshold in the second configuration as described above. In some embodiments, the threshold condition may be configured by the network device 140. For example, the threshold condition may be configured as the second threshold in the fourth configuration as described above.

With reference to FIG. 2, upon determination of the set of activated RLC entities, the terminal device 110 transmits 260 a set of duplications of a PDCP packet to the terminal device 120 via the set of activated RLC entities.

With the process 200, packet duplication for sidelink transmission may be well supported.

### Example Implementation of Methods

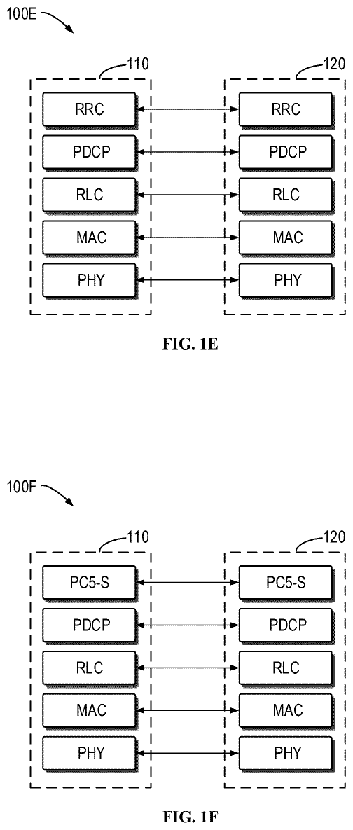

Accordingly, embodiments of the present disclosure provide methods of communication implemented at a terminal device and a network device. These methods will be described below with reference to FIGS. 3 to 6.

In context of the present disclosure, a first terminal device may refer to an initiating party of sidelink communication, and the second terminal device may refer to a peer party of the sidelink communication. A first network device may refer to a network device serving the first terminal device, and the second network device may refer to a network device serving the second terminal device. The first network device and the second network device may be the same device or different devices.

FIG. 3 illustrates an example method 300 of communication implemented at a first terminal device in accordance with some embodiments of the present disclosure. For example, the method 300 may be performed at the terminal device 110 as shown in FIG. 1A. For the purpose of discussion, in the following, the method 300 will be described with reference to FIG. 1A. It is to be understood that the method 300 may include additional blocks not shown and/or may omit some blocks as shown, and the scope of the present disclosure is not limited in this regard.

At block 310, a first terminal device (e.g., the terminal device 110) receives, from a first network device (e.g., the network device 130), a sidelink configuration comprising a first configuration of packet duplication for at least one SL RB.

In some embodiments, the first configuration may comprise at least one of the following: a set of carriers associated with a logical channel of a SL RB when the packet duplication is activated; a first threshold used for determination of the number of activated RLC entities in the set of activated RLC entities; a set of identities of logical channels used for the packet duplication; or information of a primary carrier for sidelink.

In some embodiments, the SL RB is a SL SRB or a SL DRB. In some embodiments, the first threshold is associated with at least one of a QoS parameter of the PDCP packet or SL RSRP of a carrier for sidelink.

At block 320, the terminal device 110 determines, at least based on the first configuration, a set of activated RLC entities associated with a PDCP entity for a SL RB.

In some embodiments, the terminal device 110 may determine the set of activated RLC entities from RLC entities configured for the packet duplication based on a QoS parameter of a PDCP packet. In some embodiments, if a value of the QoS parameter is below a threshold QoS parameter value, the terminal device 110 may determine that the RLC entities configured for the packet duplication are activated. If a value of the QoS parameter is below the threshold QoS parameter value, the terminal device 110 may determine that a predetermined number of RLC entities are activated.

In some embodiments, the terminal device 110 may determine the set of activated RLC entities from RLC entities configured for the packet duplication based on SL RSRP of a carrier. In some embodiments, the carrier may be a carrier having a highest SL RSRP among carriers of the terminal device 110. In some embodiments, the carrier may be a primary carrier.

In some embodiments, if the SL RSRP of the carrier is below threshold RSRP, the terminal device 110 may determine that the RLC entities configured for the packet duplication are activated. If the SL RSRP of the carrier is below threshold RSRP, the terminal device 110 may determine that a predetermined number of RLC entities are activated.

In some embodiments, the terminal device 110 may receive, from the network device 130, an indication indicating activation or deactivation of RLC entities for the packet duplication, and determine the set of activated RLC entities based on the indication. In some embodiments, the indication may comprise at least one of the following: an identity of the SL RB on an air interface; a bit indicating whether the packet duplication is activated or deactivated for the SL RB; or a bitmap indicating whether each RLC entity is activated or deactivated for the SL RB, each bit in the bitmap being associated with a RLC bearer configuration of one of the RLC entities for the packet duplication.

In some embodiments, the terminal device 110 may receive, from the terminal device 120, an indication indicating activation or deactivation of RLC entities for the packet duplication, and determine the set of activated RLC entities based on the indication. In some embodiments, the indication may comprise at least one of the following: an identity of the sidelink radio bearer on a sidelink interface; a bit indicating whether the packet duplication is activated or deactivated for the SL RB; or a bitmap indicating whether each RLC entity is activated or deactivated for the SL RB, each bit in the bitmap being associated with a LCID of one of the RLC entities for the packet duplication.

At block 330, the terminal device 110 transmits a set of duplications of a PDCP packet to a second terminal device (e.g., the terminal device 120) via the set of activated RLC entities.

In some embodiments, the terminal device 110 may transmit, to the terminal device 120 via a sidelink between the terminal devices 110 and 120, a second configuration of packet duplication for at least one SL RB.

In some embodiments, the second configuration may comprise at least one of the following: the number of secondary RLC entities associated with a SL RB; a set of RLC configurations for a set of secondary RLC entities; a set of identities of logical channels used for a set of secondary RLC entities for the packet duplication; a set of carriers associated with a SL RB when the packet duplication is activated; or a second threshold used for triggering the terminal device 120 to transmit an indication to the terminal device 110, the indication indicating activation or deactivation of RLC entities for the packet duplication.

In some embodiments, the terminal device 110 may transmit, to the network device 130, a message requesting packet duplication for one destination or a sidelink QoS flow.

With the method 300, a terminal device may perform packet duplication for sidelink transmission based on a configuration of packet duplication.

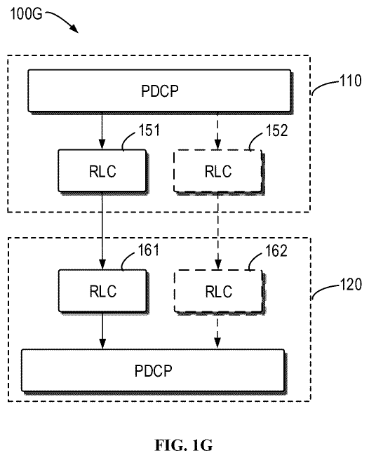

FIG. 4 illustrates an example method 400 of communication implemented at a second terminal device in accordance with some embodiments of the present disclosure. For example, the method 400 may be performed at the terminal device 120 as shown in FIG. 1A. For the purpose of discussion, in the following, the method 400 will be described with reference to FIG. 1A. It is to be understood that the method 400 may include additional blocks not shown and/or may omit some blocks as shown, and the scope of the present disclosure is not limited in this regard.

As shown in FIG. 4, at block 410, a second terminal device (e.g., the terminal device 120) may receive, via a sidelink between the terminal device 120 and a first terminal device (e.g., the terminal device 110), a second configuration of packet duplication for at least one SL RB.

At block 420, the terminal device 120 may transmit information of the second configuration to a second network device (e.g., the network device 140).

In some embodiments, the information of the second configuration may comprise at least one of the following: the number of secondary RLC entities associated with a SL RB; a set of identities of logical channels used for a set of secondary RLC entities for the packet duplication; a set of carriers associated with a SL RB when the packet duplication is activated; or a second threshold used for triggering the terminal device 120 to transmit an indication to the terminal device 110, the indication indicating activation or deactivation of RLC entities for the packet duplication.

In some embodiments, the terminal device 120 may receive, from the network device 140, at least one of the following: a third configuration of packet duplication of a transmit side; and a fourth configuration of packet duplication of a receive side. In some embodiments, the fourth configuration may comprise a second threshold used for triggering the terminal device 120 to transmit an indication to the terminal device 110, the indication indicating activation or deactivation of RLC entities for the packet duplication.

In some embodiments, the terminal device 120 may transmit, to the terminal device 110, an indication indicating activation or deactivation of RLC entities for the packet duplication. In some embodiments, the indication may comprise at least one of the following: an identity of a SL RB on a sidelink interface; a bit indicating whether the packet duplication is activated or deactivated for a SL RB; or a bitmap indicating whether each RLC entity is activated or deactivated for a SL RB, each bit in the bitmap being associated with a LCID of one of the RLC entities for the packet duplication.

In some embodiments, if QoS performance of a SL RB is worse than threshold performance, the terminal device 120 may transmit the indication indicating the activation of RLC entities for the packet duplication. If the QoS performance of the SL RB is better than the threshold performance, the terminal device 120 may transmit the indication indicating the deactivation of RLC entities for the packet duplication.

In some embodiments, if a channel condition of the sidelink is worse than threshold condition, the terminal device 120 may transmit the indication indicating the activation of RLC entities for the packet duplication. If the channel condition of the sidelink is better than the threshold condition, the terminal device 120 may transmit the indication indicating the deactivation of RLC entities for the packet duplication.

With the method 400, a terminal device may perform packet duplication for sidelink reception based on a configuration of packet duplication.

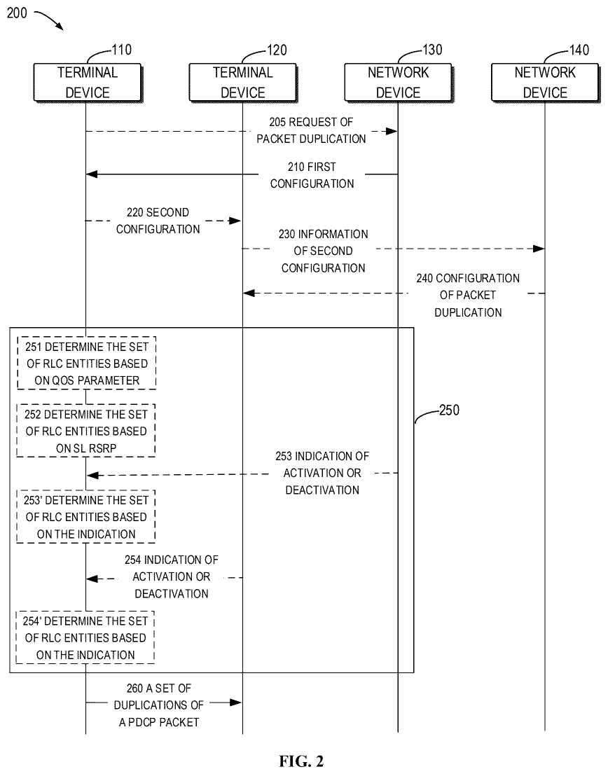

FIG. 5 illustrates an example method 500 of communication implemented at a first network device in accordance with some embodiments of the present disclosure. For example, the method 500 may be performed at the network device 130 as shown in FIG. 1A. For the purpose of discussion, in the following, the method 500 will be described with reference to FIG. 1A. It is to be understood that the method 500 may include additional blocks not shown and/or may omit some blocks as shown, and the scope of the present disclosure is not limited in this regard.

At block 510, a first network device (e.g., the network device 130) transmits, to a first terminal device (e.g., the terminal device 110), a sidelink configuration comprising a first configuration of packet duplication for at least one SL RB.

In some embodiments, the first configuration may comprise at least one of the following: a set of carriers associated with a logical channel of a SL RB when the packet duplication is activated; a first threshold used for determination of the number of activated RLC entities in the set of activated RLC entities; a set of identities of logical channels used for the packet duplication; or information of a primary carrier for sidelink.

In some embodiments, the SL RB is a SL SRB or a SL DRB.

In some embodiments, the first threshold is associated with at least one of a QoS parameter of the PDCP packet or SL RSRP of a carrier.

In some embodiments, the network device 130 may transmit, to the terminal device 110, an indication indicating activation or deactivation of RLC entities for the packet duplication. In some embodiments, the indication may comprise at least one of the following: an identity of the SL RB on an air interface; a bit indicating whether the packet duplication is activated or deactivated for the SL RB; or a bitmap indicating whether each RLC entity is activated or deactivated for the SL RB, each bit in the bitmap being associated with a RLC bearer configuration of one of the RLC entities for the packet duplication.

In some embodiments, the network device 130 may receive, from the terminal device 110, a message requesting packet duplication for one destination or a sidelink QoS flow.

With the method 500, a network device may configure packet duplication for sidelink transmission.

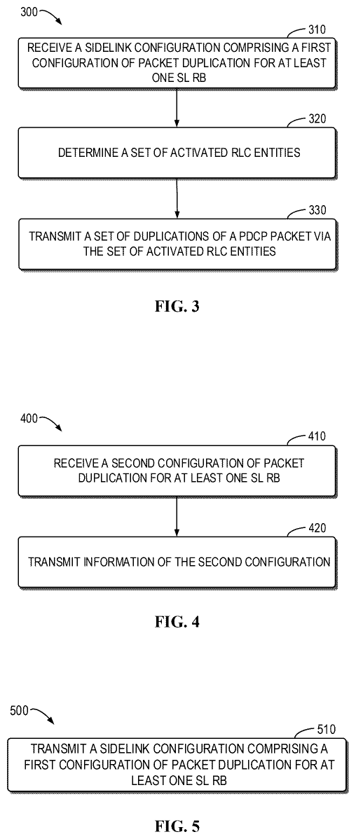

FIG. 6 illustrates an example method 600 of communication implemented at a second network device in accordance with some embodiments of the present disclosure. For example, the method 600 may be performed at the network device 140 as shown in FIG. 1A. For the purpose of discussion, in the following, the method 600 will be described with reference to FIG. 1A. It is to be understood that the method 600 may include additional blocks not shown and/or may omit some blocks as shown, and the scope of the present disclosure is not limited in this regard.

As shown in FIG. 6, at block 610, a second network device (e.g., the network device 140) may receive, from a second terminal device (e.g., the terminal device 120), information of a second configuration of packet duplication for at least one SL RB.

In some embodiments, the information of the second configuration may comprise at least one of the following: the number of secondary RLC entities associated with a SL RB; a set of identities of logical channels used for a set of secondary RLC entities for the packet duplication; a set of carriers associated with a SL RB when the packet duplication is activated; or a second threshold used for triggering the terminal device 120 to transmit an indication to a first terminal device (e.g., the terminal device 110), the indication indicating activation or deactivation of RLC entities for the packet duplication.

At block 620, the network device 140 transmits, to the terminal device 120, at least one of the following: a third configuration of packet duplication of a transmit side; or a fourth configuration of packet duplication of a receive side.

In some embodiments, the fourth configuration may comprise a second threshold used for triggering the terminal device 120 to transmit an indication to the terminal device 110, the indication indicating activation or deactivation of RLC entities for the packet duplication.

With the method 600, a network device may configure packet duplication for sidelink reception and transmission.

It is to be understood that the operations of methods 300 to 600 are similar as that described in connection with FIG. 2, and thus other details are not repeated here for concise.

### Example Implementation of Devices and Apparatuses

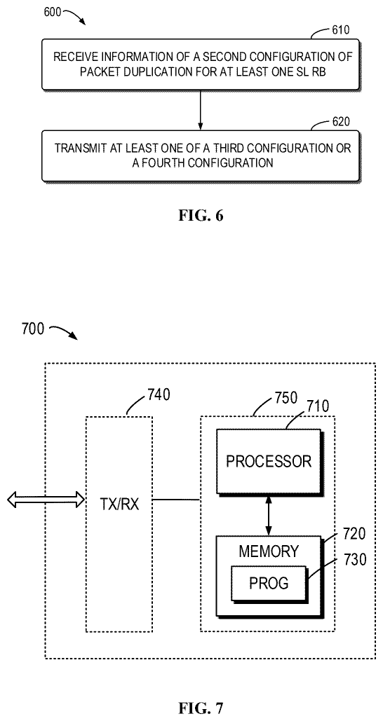

FIG. 7 is a simplified block diagram of a device 700 that is suitable for implementing embodiments of the present disclosure. The device 700 can be considered as a further example implementation of the terminal device 110 or the network device 120 or the network device 130 as shown in FIG. 1A. Accordingly, the device 700 can be implemented at or as at least a part of the terminal device 110 or the network device 120 or the network device 130.

As shown, the device 700 includes a processor 710, a memory 720 coupled to the processor 710, a suitable transmitter (TX) and receiver (RX) 740 coupled to the processor 710, and a communication interface coupled to the TX/RX 740. The memory 710 stores at least a part of a program 730. The TX/RX 740 is for bidirectional communications. The TX/RX 740 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 730 is assumed to include program instructions that, when executed by the associated processor 710, enable the device 700 to operate in accordance with the embodiments of the present disclosure, as discussed herein with reference to FIGS. 1A to 6. The embodiments herein may be implemented by computer software executable by the processor 710 of the device 700, or by hardware, or by a combination of software and hardware. The processor 710 may be configured to implement various embodiments of the present disclosure. Furthermore, a combination of the processor 710 and memory 720 may form processing means 750 adapted to implement various embodiments of the present disclosure.

The memory 720 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 720 is shown in the device 700, there may be several physically distinct memory modules in the device 700. The processor 710 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

In some embodiments, a first terminal device comprises a circuitry configured to: receive, from a first network device, a sidelink configuration comprising a first configuration of packet duplication for at least one sidelink radio bearer; determine, at least based on the first configuration, a set of activated RLC entities associated with a PDCP entity for a sidelink radio bearer; and transmit a set of duplications of a PDCP packet to a second terminal device via the set of activated RLC entities.

In some embodiments, a second terminal device comprises a circuitry configured to: receive, via a sidelink between the second terminal device and a first terminal device, a second configuration of packet duplication for at least one sidelink radio bearer; and transmit information of the second configuration to a second network device.

In some embodiments, a first network device comprises a circuitry configured to: transmit, to a first terminal device, a sidelink configuration comprising a first configuration of packet duplication for at least one sidelink radio bearer.

In some embodiments, a second network device comprises a circuitry configured to: receive, from a second terminal device, information of a second configuration of packet duplication for at least one sidelink radio bearer; and transmit, to the second terminal device, at least one of the following: a third configuration of packet duplication of a transmit side; a fourth configuration of packet duplication of a receive side.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure may provide the following solutions.

In one solution, a method of communication comprises: receiving, at a first terminal device and from a first network device, a sidelink configuration comprising a first configuration of packet duplication for at least one sidelink radio bearer; determining, at least based on the first configuration, a set of activated radio link control (RLC) entities associated with a packet data convergence protocol (PDCP) entity for a sidelink radio bearer; and transmitting a set of duplications of a PDCP packet to a second terminal device via the set of activated RLC entities.

In some embodiments, the first configuration comprises at least one of the following: a set of carriers associated with a logical channel of a sidelink radio bearer when the packet duplication is activated; a first threshold used for determination of the number of activated RLC entities in the set of activated RLC entities; a set of identities of logical channels used for the packet duplication; or information of a primary carrier for sidelink.

In some embodiments, the sidelink radio bearer is a sidelink signaling radio bearer or a sidelink data radio bearer.

In some embodiments, the first threshold is associated with at least one of a quality of service (QoS) parameter of the PDCP packet or sidelink reference signal receiving power (SL RSRP) of a carrier.

In some embodiments, the method as described above further comprises: transmitting, to the second terminal device via a sidelink between the first and second terminal devices, a second configuration of packet duplication for at least one sidelink radio bearer.

In some embodiments, the second configuration comprises at least one of the following: the number of secondary RLC entities associated with a sidelink radio bearer; a set of RLC configurations for a set of secondary RLC entities; a set of identities of logical channels used for a set of secondary RLC entities for the packet duplication; a set of carriers associated with a sidelink radio bearer when the packet duplication is activated; or a second threshold used for triggering the second terminal device to transmit an indication to the first terminal device, the indication indicating activation or deactivation of RLC entities for the packet duplication.

In some embodiments, the method as described above comprises determining the set of activated RLC entities by at least one of the following: determining the set of activated RLC entities from RLC entities configured for the packet duplication based on a quality of service (QoS) parameter of a PDCP packet; or determining the set of activated RLC entities from RLC entities configured for the packet duplication based on sidelink reference signal receiving power (SL RSRP) of a carrier for sidelink.

In some embodiments, the method as described above comprises determining the set of activated RLC entities based on the QoS parameter by: in accordance with a determination that a value of the QoS parameter is below a threshold QoS parameter value, determining that the RLC entities configured for the packet duplication are activated; or in accordance with a determination that a value of the QoS parameter is below the threshold QoS parameter value, determining that a predetermined number of RLC entities are activated.

In some embodiments, the carrier is a carrier having a highest SL RSRP among carriers of the first terminal device or the carrier is a primary carrier. In such embodiment, the method as described above comprises determining the set of activated RLC entities based on the SL RSRP of the carrier by: in accordance with a determination that the SL RSRP of the carrier is below threshold RSRP, determining that the RLC entities configured for the packet duplication are activated; or in accordance with a determination that the SL RSRP of the carrier is below threshold RSRP, determining that a predetermined number of RLC entities are activated.

In some embodiments, the method as described above comprises determining the set of activated RLC entities by: receiving, from the first network device, an indication indicating activation or deactivation of RLC entities for the packet duplication; and determining the set of activated RLC entities based on the indication. In some embodiments, the indication comprises at least one of the following: an identity of the sidelink radio bearer on an air interface; a bit indicating whether the packet duplication is activated or deactivated for the sidelink radio bearer; or a bitmap indicating whether each RLC entity is activated or deactivated for the sidelink radio bearer, each bit in the bitmap being associated with a RLC bearer configuration of one of the RLC entities for the packet duplication.

In some embodiments, the method as described above comprises determining the set of activated RLC entities comprises: receiving, from the second terminal device, an indication indicating activation or deactivation of RLC entities for the packet duplication; and determining the set of activated RLC entities based on the indication. In some embodiments, the indication comprises at least one of the following: an identity of the sidelink radio bearer on a sidelink interface; a bit indicating whether the packet duplication is activated or deactivated for the sidelink radio bearer; or a bitmap indicating whether each RLC entity is activated or deactivated for the sidelink radio bearer, each bit in the bitmap being associated with a logical channel identity (LCID) of one of the RLC entities for the packet duplication.

In some embodiments, the method as described above further comprises: transmitting, to the first network device, a message requesting packet duplication for one destination or a sidelink quality of service (QoS) flow.

In another solution, a method of communication comprises: receiving, at a second terminal device via a sidelink between the second terminal device and a first terminal device, a second configuration of packet duplication for at least one sidelink radio bearer; and transmitting information of the second configuration to a second network device.

In some embodiments, the information of the second configuration comprises at least one of the following: the number of secondary RLC entities associated with a sidelink radio bearer; a set of identities of logical channels used for a set of secondary RLC entities for the packet duplication; a set of carriers associated with a sidelink radio bearer when the packet duplication is activated; or a second threshold used for triggering the second terminal device to transmit an indication to the first terminal device, the indication indicating activation or deactivation of RLC entities for the packet duplication.

In some embodiments, the method as described above further comprises: receiving, from the second network device, at least one of the following: a third configuration of packet duplication of a transmit side; and a fourth configuration of packet duplication of a receive side.

In some embodiments, the fourth configuration comprises a second threshold used for triggering the second terminal device to transmit an indication to the first terminal device, the indication indicating activation or deactivation of RLC entities for the packet duplication.

In some embodiments, the method as described above further comprises: transmitting, to the first terminal device, an indication indicating activation or deactivation of RLC entities for the packet duplication. In some embodiments, the indication comprises at least one of the following: an identity of a sidelink radio bearer on a sidelink interface; a bit indicating whether the packet duplication is activated or deactivated for a sidelink radio bearer; or a bitmap indicating whether each RLC entity is activated or deactivated for a sidelink radio bearer, each bit in the bitmap being associated with a logical channel identity (LCID) of one of the RLC entities for the packet duplication.

In some embodiments, the method as described above comprises transmitting the indication by: in accordance with a determination that QoS performance of a sidelink radio bearer is worse than threshold performance, transmitting the indication indicating the activation of RLC entities for the packet duplication; or in accordance with a determination that the QoS performance of the sidelink radio bearer is better than the threshold performance, transmitting the indication indicating the deactivation of RLC entities for the packet duplication.

In some embodiments, the method as described above comprises transmitting the indication by: in accordance with a determination that a channel condition of the sidelink is worse than threshold condition, transmitting the indication indicating the activation of RLC entities for the packet duplication; or in accordance with a determination that the channel condition of the sidelink is better than the threshold condition, transmitting the indication indicating the deactivation of RLC entities for the packet duplication.

In another solution, a method of communication comprises: transmitting, at a first network device and to a first terminal device, a sidelink configuration comprising a first configuration of packet duplication for at least one sidelink radio bearer.

In some embodiments, the first configuration comprises at least one of the following: a set of carriers associated with a logical channel of a sidelink radio bearer when the packet duplication is activated; a first threshold used for determination of the number of activated RLC entities in the set of activated RLC entities; a set of identities of logical channels used for the packet duplication; or information of a primary carrier for sidelink.

In some embodiments, the sidelink radio bearer is a sidelink signaling radio bearer or a sidelink data radio bearer.

In some embodiments, the first threshold is associated with at least one of a quality of service (QoS) parameter of the PDCP packet or sidelink reference signal receiving power (SL RSRP) of a carrier.

In some embodiments, the method as described above further comprises: transmitting, to the first terminal device, an indication indicating activation or deactivation of RLC entities for the packet duplication. In some embodiments, the indication comprises at least one of the following: an identity of the sidelink radio bearer on an air interface; a bit indicating whether the packet duplication is activated or deactivated for the sidelink radio bearer; or a bitmap indicating whether each RLC entity is activated or deactivated for the sidelink radio bearer, each bit in the bitmap being associated with a RLC bearer configuration of one of the RLC entities for the packet duplication.

In some embodiments, the method as described above further comprises: receiving, from the first terminal device, a message requesting packet duplication for one destination or a sidelink quality of service (QoS) flow.

In another solution, a method of communication comprises: receiving, at a second network device and from a second terminal device, information of a second configuration of packet duplication for at least one sidelink radio bearer; and transmitting, to the second terminal device, at least one of the following: a third configuration of packet duplication of a transmit side; or a fourth configuration of packet duplication of a receive side.

In some embodiments, the information of the second configuration comprises at least one of the following: the number of secondary RLC entities associated with a sidelink radio bearer; a set of identities of logical channels used for a set of secondary RLC entities for the packet duplication; a set of carriers associated with a sidelink radio bearer when the packet duplication is activated; or a second threshold used for triggering the second terminal device to transmit an indication to a first terminal device, the indication indicating activation or deactivation of RLC entities for the packet duplication.

In some embodiments, the fourth configuration comprises a second threshold used for triggering the second terminal device to transmit an indication to a first terminal device, the indication indicating activation or deactivation of RLC entities for the packet duplication.

In another solution, a device of communication comprises a processor configured to cause the device to perform any of the methods as summarized above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1A to 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires. a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method performed by a first terminal device, comprising:
receiving a first sidelink configuration information associated with packet data convergence protocol (PDCP) duplication from a network device; and
transmitting a second sidelink configuration information associated with the PDCP duplication to a second terminal device,
wherein the second sidelink configuration information associated with the PDCP duplication comprises configuration information associated with an additional sidelink radio link control (RLC) for sidelink signaling radio bearer (SRB) or data radio bearer (DRB).

22. The method of claim 21, wherein the second sidelink configuration information associated with the PDCP duplication further comprises logical channel identities for sidelink packet duplication.

23. The method of claim 21, wherein the first terminal device transmits the second sidelink configuration information associated with the PDCP duplication to the second terminal device via a RRCReconfigurationSidelink message, the RRCReconfigurationSidelink message being a PC5 radio resource control (RRC) message.

24. The method of claim 21, wherein the first sidelink configuration information associated with the PDCP duplication is for sidelink DRB.

25. A method performed by a second terminal device, comprising:
receiving a second sidelink configuration information associated with packet data convergence protocol (PDCP) duplication from a first terminal device,
wherein the second sidelink configuration information associated with the PDCP duplication comprises configuration information associated with an additional sidelink radio link control (RLC) for sidelink signaling radio bearer (SRB) or data radio bearer (DRB).

26. The method of claim 25, wherein the second sidelink configuration information associated with the PDCP duplication further comprises logical channel identities for sidelink packet duplication.

27. The method of claim 25, wherein the second terminal device receives the second sidelink configuration information associated with the PDCP duplication from the first terminal device via a RRCReconfigurationSidelink message, the RRCReconfigurationSidelink message being a PC5 radio resource control (RRC) message.

28. A first terminal device, comprising a processor configured to:
receive a first sidelink configuration information associated with packet data convergence protocol (PDCP) duplication from a network device; and
transmit a second sidelink configuration information associated with the PDCP duplication to a second terminal device,
wherein the second sidelink configuration information associated with the PDCP duplication comprises configuration information associated with an additional sidelink radio link control (RLC) for sidelink signaling radio bearer (SRB) or data radio bearer (DRB).

29. The first terminal device of claim 28, wherein the second sidelink configuration information associated with the PDCP duplication further comprises logical channel identities for sidelink packet duplication.

30. The first terminal device of claim 28, wherein the first terminal device transmits the second sidelink configuration information associated with the PDCP duplication to the second terminal device via a RRCReconfigurationSidelink message, the RRCReconfigurationSidelink message being a PC5 radio resource control (RRC) message.

31. The first terminal device of claim 28, wherein the first sidelink configuration information associated with the PDCP duplication is for sidelink DRB.
